(19) United States
(12) Patent Application Publication
(10) Pub. No.: US 2005/0108084 A1
(43) Pub. Date: May 19, 2005

(54) Methods and systems for valuing a business decision

(76) Inventors: Sridhar Ramamoorti, Naperville, IL (US); Peter Freeman, Chicago, IL (US); Anurag Agarwal, Gainesville, FL (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 10/914,595

(22) Filed: Aug. 9, 2004

Related U.S. Application Data
(60) Provisional application No. 60/493,567, filed on Aug. 8, 2003.

(51) Int. Cl. G06F 17/60

(52) U.S. Cl. 705/10; 705/1

(57) ABSTRACT

Methods, systems, and processor instructions to determine a first direct cost associated with at least a partial implementation of a business decision, the first direct cost including at least one of productivity gains and losses, determine a second direct cost based on a non-implementation of the business decision, the second direct cost based on the productivity gains and losses, determine a first risk reduction associated with at least a partial implementation of the business decision, the first risk reduction based on a business relationship risk(s), determine a second risk reduction associated with a non-implementation of the business decision, the second risk reduction based on the business relationship risk(s), and, associate the business decision with a value, the value corresponding to a sum between differences of: (i) the first direct cost and the second direct cost, and, (ii) the first risk reduction and the second risk reduction.

### CLAIM OF PRIORITY

This application claims priority to U.S. Ser. No. 60/493,567, filed on Aug. 8, 2003, the contents of which are incorporated herein by reference in their entirety.

### BACKGROUND

(1) Field

The disclosed methods and systems relate generally to evaluating business decisions, and more particularly to associating a value with a business decision.

(2) Description of Relevant Art

Corporations typically employ a combination of in-house and/or general counsel, and outside attorneys (e.g., law firm attorneys) to administer the various legal tasks that the corporation may encounter. One problem with such a scheme is determining the proper combination of general counsel to outside counsel. In making such a determination, a corporation may attempt to place valuations on the outside counsel and the general counsel. Because of billing practices used by outside counsel, it is often easier to quantify the value provided by outside counsel, and thus, a problem remains for determining the contributions and/or value provided by general counsel. This quantification can be further complicated by different roles and/or factors related to general counsel responsibilities, where such roles and/or factors can vary over time, thereby making it difficult provide a consistent valuation scheme. Business decisions that can be affected by issues such as the value of general counsel can be difficult to assess.

### SUMMARY

The disclosed methods and systems relate to providing valuation, and/or a method for evaluating, a business decision that can include, for example, general counsel (e.g., “in-house” or “inside” counsel). In an embodiment directed to evaluating general counsel and/or a business decision to implement Early Dispute Resolution (EDR), the disclosed methods and systems allow for an approach that evaluates case and portfolio management, budgeting and reserves, external and internal process cost containment, disposition cost minimization, and business risk analysis and reduction. The disclosed methods and systems can thus provide a valuation that can be based on a direct costs savings, and a risk reduction savings that can be attributed to the general counsel's activities. In some embodiments, the direct cost savings can be due to shorter cycle times, lower external and internal process costs, lower settlement and/or disposition costs, and reserve capital re-deployment. For example, risk reduction savings can include evaluation of business relationship risks, regulatory risks, insurance risks, privacy and/or security risks, and catastrophic risks. Based on direct cost and risk reduction savings, a decision may be made (e.g., corporate executives or others) as to the business decision, and/or to the effectiveness of aspects related to the business decision, such as general counsel.

In an EDR embodiment, the disclosed method and systems can be implemented using a graphical user interface (GUI) that can provide for a user or another to model and/or illustrate selected direct cost and risk reduction savings based on comparing before/after EDR (Early Dispute Resolution) parameters. Such model can allow a user or another to vary a variety of before/after EDR parameters that affect the direct cost and risk reduction savings, such that a valuation of the general counsel can be determined and/or predicted based on the EDR parameters.

Accordingly, although the disclosed embodiments relate to a business decision related to EDR/ADR versus litigation, the disclosed methods and systems can be applied to other business decisions. The disclosed methods and systems can thus include a processor program product disposed on a processor-readable medium, the processor program product having processor instructions for causing at least one processor to: determine a first direct cost associated with at least a partial implementation of a business decision, the first direct cost including at least one of productivity gains and losses, determine a second direct cost based on a non-implementation of the business decision, the second direct cost including at least one of productivity gains and losses, determine a first risk reduction associated with at least a partial implementation of the business decision, the first risk reduction based on at least one business relationship risk, determine a second risk reduction associated with a non-implementation of the business decision, the second risk reduction based on the at least one business relationship risk, and, associate the business decision with a value, the value corresponding to a sum between: (i) a difference between the first direct cost and the second direct cost, and, (ii) a difference between the first risk reduction and the second risk reduction.

In an embodiment, the business decision can include alternative dispute resolution (ADR) and/or early dispute resolution (EDR).

The productivity gains and/or losses can include a cost of diverted time, a cost of diverted resources, a value of diverted time, a value of diverted resources, and/or a productivity rate.

The first direct cost and the second direct cost can also include at least one process and settlement cost, which can include expenditures to third parties, expenditures to experts, expenditures to consultants, internal administrative costs, a number of new cases, actual costs of using alternatives, estimated costs of using alternatives, actual costs of using prevention, and/or estimated costs of using prevention. The process and settlement cost(s) can be based on a maximum time for disposition of an EDR case, peak disposition month for an EDR case, maximum time for switching between litigation and EDR, peak switch month for switching between litigation and EDR, average process costs per EDR case per month, average settlement cost per EDR case, percent of cases switching from EDR to ligitation, maximum time for disposition of a litigation case, peak disposition month for a litigation case, maximum time for switching between EDR and litigation, peak switch month for switching between EDR and litigation, average process costs per litigation case per month, average settlement cost per litigation case, and/or percent of cases switching from litigation to EDR. The process and settlement cost(s) can further be based on a phased-implementation of the business decision.

The first direct cost and the second direct cost can also include a reserve saving(s) that can include an amount reserved for contingency cases, an amount of excess reserves, a hurdle rate, and/or an annual revenue.

In one embodiment of the disclosed methods and systems, the business relationship risk(s) can include a risk(s) of losing an alliance, an employee risk(s), a supplier relationship risk(s), a capital provider/rate change risk(s), a customer risk(s), a competitor risk(s), a regulatory risk(s), and/or an insurance risk(s). A risk(s) of losing an alliance can be based on a number of partners, a percentage of partners lost, lost profits, lost intellectual property, average failure separation cost, average cost to divest per venture, average initial capital outlay per venture, and/or a growth rate via alliances. An employee risk(s) can be based on a cost of replacing an employee, at least one interim cost, and/or at least one human resource cost. A supplier relationship risk can be based on a number of key suppliers, a number of non-key suppliers, and/or a reduced profit from a lost supplier. A capital provider/rate change risk(s) can be based on a total debt, a weighted average borrowing, and/or at least one shareholder class action cost. A customer risk can be based on lost patrons, acquisition costs, acclimation costs, lost profits, and/or costs of increased public relations. A competitor risk(s) can be based on a number of SBU competitors, a number of hostile relationships, and/or an opportunity cost of fostering alliances. A regulatory risk can be based on a regulation cost, a lobbying cost, and/or lost profits from increased government regulations. An insurance risk(s) can be based on claims received, premiums paid, percentage reimbursed by a provider, and a percent reduction in premium.

In an embodiment of the disclosed methods and systems, the first risk reduction and the second risk reduction can be based on an intellectual property risk(s). An intellectual property risk(s) can include damage to intellectual property and/or loss of intellectual property.

In some embodiments, the first risk reduction and the second risk reduction can be based a litigation outcome risk(s). A litigation outcome risk(s) can include a potential exposure risk and/or a likelihood of exposure risk.

In the disclosed methods and systems, the first risk reduction and the second risk reduction can be based on an adverse publicity risk(s). The adverse publicity risk(s) can include damage to brand name, direct advertising expenses, corrective advertising expenses, selling costs, general costs, and administrative costs, increased lobbying, and/or increased regulation.

Other objects and advantages will become apparent hereinafter in view of the specification and drawings.

### BRIEF DESCRIPTION OF THE DRAWINGS

FIG. 1 is a general block diagram showing some components for one embodiment of the disclosed valuation model;

FIG. 2A-B show various representations of a two-tiered valuation process employed by the model;

FIG. 2C shows one embodiment of the model when the business decision include EDR;

FIG. 3 illustrates a settlement distribution for settling cases using EDR;

FIG. 4 illustrates some direct costs;

FIG. 5 illustrates some risk reduction factors/costs;

FIG. 6 demonstrates one interface for determining and/or valuing direct costs related to external cost savings;

FIG. 7 illustrates one interface for determining and/or valuing direct costs related to external costs and reserves;

FIG. 8 illustrates one interface for determining and/or valuing risk reductions related to catastrophic litigation/risk(s);

FIG. 9 illustrates one interface for determining and/or valuing risk reductions related to insurance risk(s);

FIG. 10 illustrates one interface for determining and/or valuing risk reductions related to partners/alliances;

FIG. 11 illustrates one interface for determining and/or valuing risk reductions related to adverse publicity risk(s); and,

FIG. 12 shows one interface for providing a value to the business decision of using EDR.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

Disclosed are methods and systems that can be used to perform and/or consider cost-benefit analyses and risk management decisions that may be associated with the prevention, management and resolution of business disputes. The disclosed methods and systems incorporate and/or combine the quantification, measurement, and evaluation of costs, benefits, probabilities, and risks associated with disputes and proceedings, litigation portfolios, and business processes, to provide a “value model” that can be employed to ascertain a value(s) of implementing a strategic business decision(s). In some embodiments, such a model can be used to evaluate and/or provide information related to members of a general counsel's office.

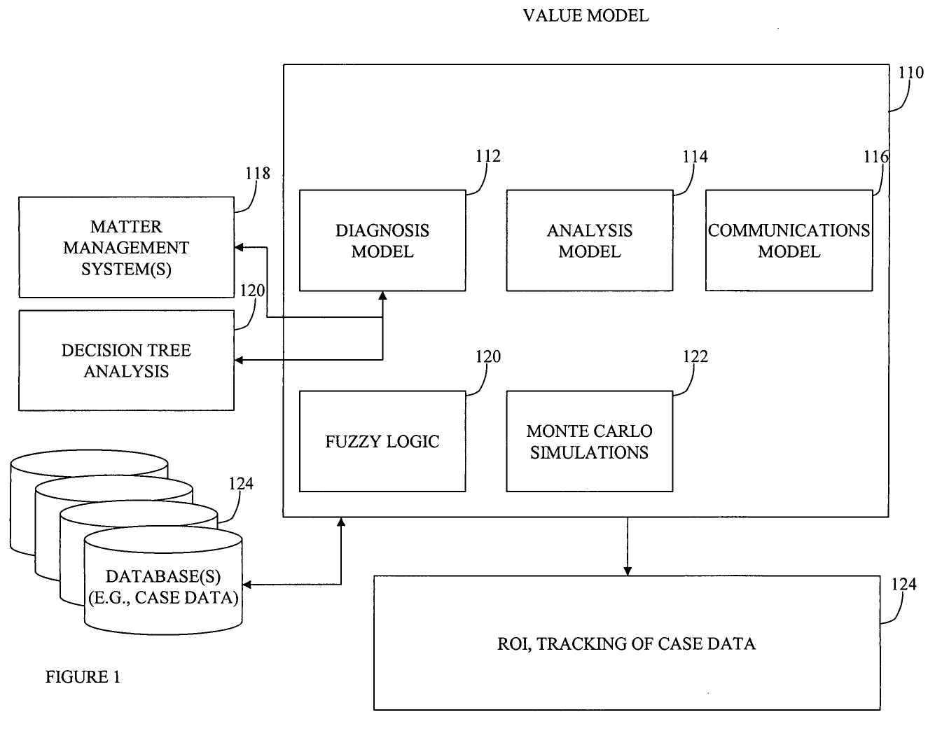

In one embodiment, and with reference to an illustrative embodiment shown in FIG. 1, the illustrated value model (“model”) 110 can integrate a “diagnosis sub-model,” 112 a “analysis sub-model,” 114 and/or a “communications sub-model” 116. In one embodiment, a diagnosis sub-model 112 can allow for business decisions involving the prevention, management, and conduct of litigation and dispute resolution. The diagnosis sub-model can facilitate cost-benefit and/or risk management analyses for business decisions utilizing a decision tree analysis, by identifying drivers and success factors of a business process, comparing the probable consequences of alternative decisions, and demonstrating one or more business decision(s) and courses of action. Such a sub-model can interface with, for example, a matter management system 118 and/or decision tree analysis 120 to provide management of complex disputes and/or extensive litigation portfolios. An analysis sub-model 114 can measure the costs, benefits, and/or risks associated with implementing a wide range of business activities and/or process efficiencies. One embodiment of the analytical sub-model can evaluate and/or include costs associated with litigation and related business conduct and business decisions. In an embodiment, a communications sub-model 116 can quantify the values of costs, benefits, and risks in objective, financial terms to facilitate communication concerning management options related to the business decision, including litigation, case management, and dispute resolution, for example. The aforementioned sub-models are referenced herein for convenience and illustrative purposes, and thus it can be understood that the sub-models can be used individually, and/or can be otherwise partitioned and/or integrated (e.g., without delineation of sub-model) without departing from the scope of the disclosed methods and systems.

The disclosed methods and systems thus can provide a model 110 that facilitates, in some embodiments, a consistent approach for estimating costs and benefits of pursuing a course of action, such as implementation of a business process (e.g., Early Dispute Resolution (EDR)), and/or a strategy for resolving a business conflict. The model 110 can allow for quantifying and comparing costs and benefits for case and portfolio management, budgeting and reserves, external and internal process cost containment, disposition cost minimization, business risk analysis and reduction, and improved business decision-making and enhanced executive confidence. The disclosed model 110 can provide a method and system for measuring the performance of in-house counsel and outside counsel, and other expert services associated with preventing, managing, and resolving disputes, including for example, the efficiency of such individuals and/or organizations. In some embodiments, the disclosed model can estimate the costs and risk of dispute resolution strategies, and project probable values for the same.

In one embodiment, the model 110 can employ fuzzy logic 120 and/or include Monte Carlo simulations 122 to project probable values of case strategies. The model 110, via its integration with matter management data (e.g., 118) and other databases 124, can provide substantially continuous tracking and refinement of decision analysis with current case data 124 and/or other data. Further the model 110 can provide, for example, a measure of the return on investment (ROI) 124 for dispute resolution strategies such as Alternative Dispute Resolution (ADR) and Early Dispute Resolution (EDR).

For illustrative purposes, the disclosed methods and systems can be understood to include a two-tiered valuation approach that can consider various factors associated with a business decision. An illustrative embodiment includes a business decision related to litigation and/or case management. According to such a two-tiered scheme, factors associated with and/or otherwise affected by an implementation of a business decision such as a case management, litigation, and/or dispute prevention decision can be understood to include: (1) direct cost variables associated with business process efficiencies; and, (2) valuation of associated business risk variables that value the intangible risk elements associated with and/or affected by implementation of the management decision or business process.

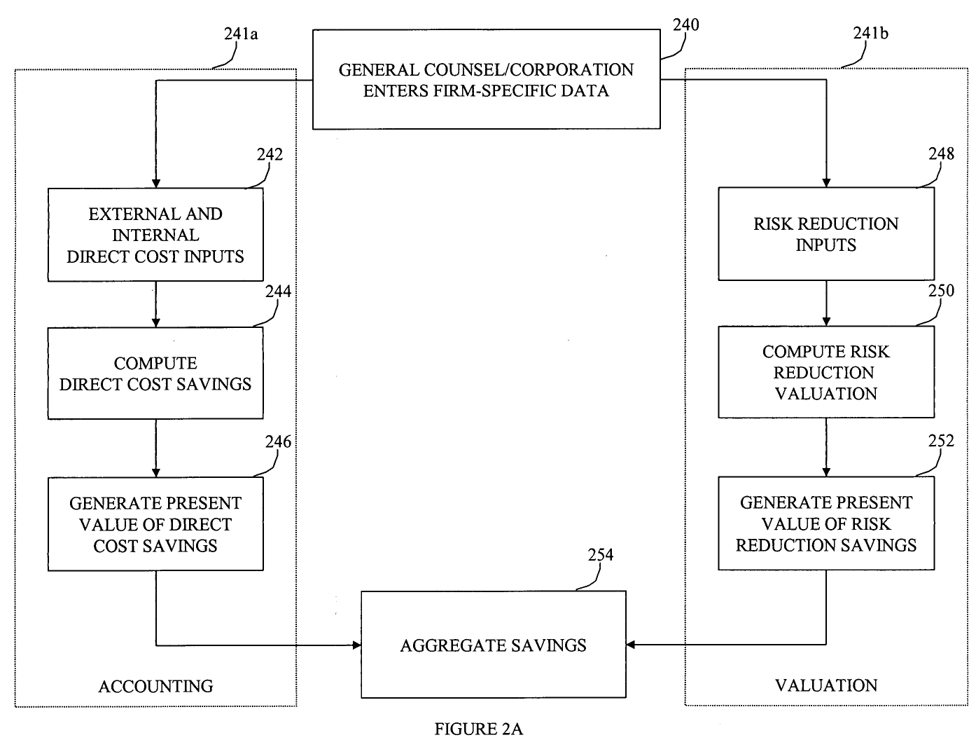

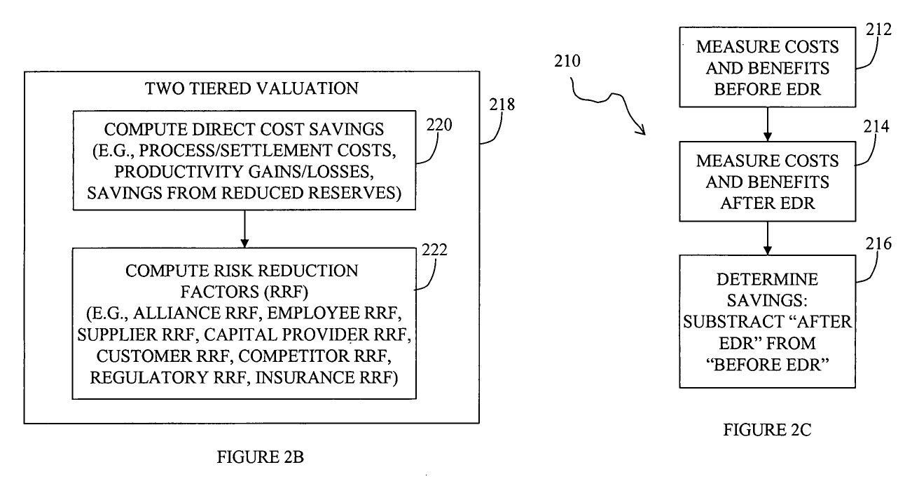

In one example embodiment shown in FIG. 2A, a corporation and/or others such as a general counsel's office can employ the disclosed model that employs the foregoing two tiered scheme. In the FIG. 2A embodiment, a user interface, for example, can allow the general counsel to enter firm-specific data 240 that can be the basis for the two tier valuation 241a, 241b. As shown in FIG. 2A, the direct cost variable analysis 241a can be understood to include and/or be characterized by accounting considerations, while the risk variable determinations 241b can be understood to include and/or be characterized by valuation considerations. Accordingly, input data can be obtained with respect to external and internal direct costs 242 and risk reduction factors 248, whereupon direct costs savings 244 and risk reduction valuations 250 can be computed and converted respectively to present value 246, 252 before being aggregated. Although FIG. 2A is merely illustrative of one embodiment in which a parallel operation is depicted, FIG. 2B shows an embodiment of the two tier valuation 218 that includes a serial computation of direct cost savings 220 and risk reduction factors/variables 222.

As an example of the model 110, consider an application of the disclosed model to Early Dispute Resolution (EDR), e.g., an assessment of a business decision to employ EDR in a matter in which a dispute is pending and/or imminent. In such an example, the disclosed model 110 can quantify the financial and economic cost savings of implementing an EDR business process by comparing financial and economic costs before and after EDR implementation. One method of determining cost savings is an arithmetic difference 216 between pre-EDR costs 212 and post-EDR costs 214. Generally, each of the before-EDR 212 and after-EDR 214 components can be accounted and/or valued in the same manner in accordance with their respective accounting or valuation standards by employing the two-tiered valuation before and after EDR.

In the disclosed illustrative embodiment, benefits before EDR 212 can be based on a sum of total processing costs and total settlement costs for a given set of cases (e.g., where a set can be one or more cases). Determining processing costs generally includes knowing the number of live and/or in-process cases, while determining settlement costs includes knowing the number of cases settled. The number of cases settled can include two categories of cases: (1) cases that settle without switching from EDR to litigation (or vice versa); and, (2) cases that settle after switching from EDR to litigation (or vice versa).

A determination for live cases can include the number of cases settled and the number of cases switched between EDR and Ligitation. In one embodiment, the number of cases settled and switched is determined by calculating the number of EDR cases being settled in the ith month, determining the number of un-switched cases settling through EDR (and Litigation) in the ith month, and determining the number of cases that switch from EDR to Litigation (and vice versa). Further, the number of cases settling that switched in a given month is determined, such that a total number of EDR and Litigation cases that settle in the ith month can be computed. A determination of the number of live cases similarly can be determined and/or computed. Accordingly, the live EDR and live Litigation (LIT) cases can be expressed as:

$$\begin{matrix}Live EDR Cases = Live EDR cases from prior month + \\ new EDR cases - \\ cases settled in EDR - \\ cases switching to LIT from EDR + \\ cases switching to EDR from LIT\end{matrix}$$

$$\begin{matrix}Live LIT Cases = Live LIT cases from prior month + \\ new LIT cases - \\ cases settled in LIT - \\ cases switching to EDR from LIT + \\ cases switching to LIT from EDR\end{matrix}$$

In such a two tiered valuation as provided herein, direct costs savings of EDR can be computed, and in some embodiments, the evaluated course of action (e.g., EDR) can be understood to be a phased implementation in that the process can take time to implement, and the effect of the process (e.g., EDR) on the model and/or input parameters can be understood to occur gradually and/or in phases. For example, if the number of cases settling through EDR is thirty percent before EDR is implemented, and seventy percent after EDR is implemented, then in some embodiments, it can be understood that such an increase may span several years such as, for example, four or five years. Further, it can be understood that the increase may not be linear, and, for example, in the first year, ten percent implementation may be recognized, with twenty-five percent in the second year, forty percent in the third year, seventy-five percent in the fourth year, and one-hundred percent in the fifth year, for example. Such a phased implementation (e.g., implemented and/or weighted over time) can affect the “after EDR” cost savings, for if only “x percent” of EDR is implemented, then only x-percent of new cases are subject to the new input values and (100−x) percent of new cases are still subject to the old (i.e., before EDR) input values. Accordingly, to calculate the after EDR process costs, live cases can be distinguished based on cases subject to new input values, and cases subject to old input values, with the proportion in each category based on the percent of EDR implemented.

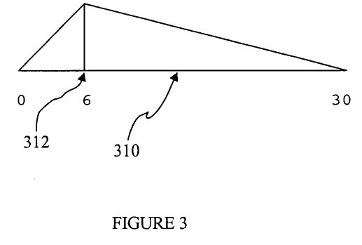

To predict a number of cases settled, the disclosed methods and systems can employ a settlement distribution, where one embodiment uses a triangular distribution as shown in FIG. 3, although other distributions can be used. With reference to the FIG. 3 settlement distribution, the base of the triangle 310 represents the number of months (e.g., thirty) for the longest case to resolve and the month corresponding to the peak of the triangle 312 represents the month of the mode or the highest frequency of cases resolved (e.g., in month six, most cases are resolved). Using this distribution, a predicted total number of cases resolving in a given month can be determined. Based on the embodiment, a user or another can change the distribution (e.g., FIG. 3, change the shape of the triangle) by changing characteristics of the distribution, where such characteristics/parameters can be input parameters that can be provided to the disclosed methods and systems using a user interface or other designation and/or input mechanism. For example, with reference to the FIG. 3 settlement distribution, the number of months can be changed to resolve a case (e.g., base of triangle), the month having the greatest frequency of cases resolved can be altered, and the area under the triangle can be designated. In the FIG. 3 embodiment, for example, the area under the triangle is one as the FIG. 3 embodiment assumes that one-hundred percent of cases are settled by thirty months.

Accordingly, with continued reference to the example FIG. 3 settlement distribution, knowing that the area of a triangle is ½*base*height, with a triangle having a base of thirty and an area of one, the height of the triangle is 2/30 or 1/15. From the height of the triangle, other points on the triangle (e.g., settlement distribution) can be computed to predict the number of cases settled in a given month (e.g., for month 22, (30−22)/(30−6)*2/30, or (8/24)*(2/30), implies 1/45th of cases are settled in month 22).

When the number of live cases is determined, the process and settlement costs can be calculated by multiplying the number of live ADR/LIT cases by the respective average process and settlement costs per month, to yield a total processing and settlement costs per month.

Referring again to FIG. 3, in the disclosed embodiments, the costs and benefits after EDR 214 can be computed 112 and/or determined using the same methodology as the “before EDR” costs. Thereafter, the overall process and settlement cost savings can be calculated as “Before EDR” costs minus “After EDR” costs per month 216. This result summed over time (e.g., by month) can be represented as an aggregate process and settlement cost savings.

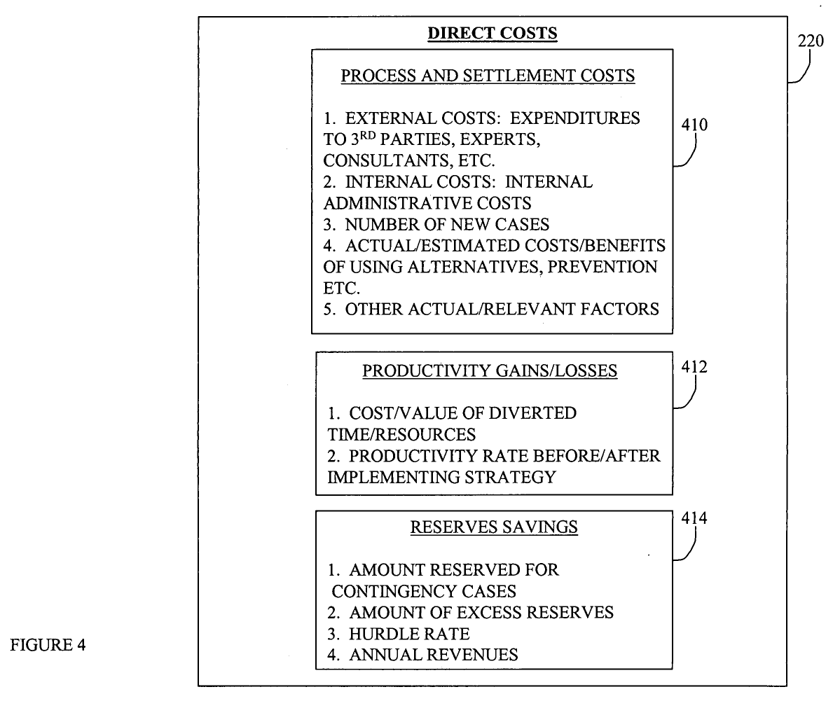

As provided herein, the aforementioned two-tiered valuation 218 can include a first tier (e.g., 220) in which direct costs can be evaluated. With further reference to FIG. 4, direct costs 220 can be understood to be variable costs and/or associated overhead that are related to the prevention, management, and/or resolution of individual conflicts, portfolios of disputes, and/or courses of business conduct or enterprises, such as mergers and joint ventures, or performance of specific departments within a company. Accordingly, some direct costs and benefits are illustrated in FIG. 4, and can be understood to include (i) process and settlement costs (internal and/or external costs) 410, (ii) productivity gains and losses 412, and (iii) savings from reduced reserves 414.

Process and settlement costs 410 can include internal and external costs. External costs include expenditures paid to third party professionals, experts, consultants, and other providers engaged in processing a conflict or managing a litigation portfolio, EDR neutrals, settlements, and awards to parties resulting from the resolution of a dispute. Based on the perspective of the party, these external costs may be cumulative or they may reduce the size of potential benefits.

Internal costs include internal administrative costs associated with the prevention, management, or resolution of the conflict or portfolio. These internal costs can include the costs of in-house professional services and in-house consultants. In one embodiment of the disclosed methods and systems, a model 110 can be based on an assumption that EDR implementation enhances productivity, and thus, internal costs which include process costs, opportunity cost of time devoted to open cases, etc., can be based on a value-added rate per hour for Office of General Counsel (OGC) and non-OGC personnel.

Based on the embodiment, process and settlement cost determination can be based on a number of new cases filed against the company in a time period (e.g., one month); actual and/or estimated process costs and/or benefits (e.g., attorney fees, administrative costs, settlements etc.) incurred under alternative scenarios of prevention, management, or resolution of a dispute; management of a litigation portfolio or pursuit of a specific business course of action; and, actual and/or other relevant factors affecting the evaluation, measurement, or calculation of process costs and benefits, such as the duration of litigation or the frequency of EDR or ADR.

Another direct cost 220 includes productivity gains and losses 412, which can be determined based on risks associated with potential personnel distraction from strategic intent. These risks can include the cost of lost value of the time and resources that are often diverted from other business objectives due to the dispute or disputes. Accordingly, determination of productivity costs can be based on the value and time of business department employees and executives devoted to managing a dispute and/or portfolio; and, the productivity rate measured as a percentage of time saved of employees before and after the implementation of a strategy or process system, such as EDR.

For example, in one sample embodiment, productivity cost savings (e.g., gains/losses) 412 can be determined based on a total number of employees of one-hundred, a number of Office of General Counsel (OGC) employees of one percent of the total number of employees, or one employee, a number of executive employees equal to ten percent of the total number of employees, or ten employees, with the remaining workers being in the category of “other” (e.g., eighty-nine employees). Furthering the example, if the OGC employee is valued at $200/hour, the executive employees are valued at $300/hour, and the other employees are valued at $40/hour, and the average number of hours worked per year per employee is 2000 hours, the following productivity rates can be determined before and after EDR:

TABLE 1

| Productivity | | | Difference | Percentage | Net |
|---|---|---|---|---|---|
| rates | Before | After | (a) | (b) | (a * b) |
| OGC | 80% | 80% | 0% | 0% | 0% |
| employee | | | | | |
| Executive | 80% | 85% | 5% | 10% | 0.5% |
| employees | | | | | |
| Other | 80% | 80% | 0% | 0% | 0% |
| employees | | | | | |

Based on these productivity rates, productivity savings of EDR can be computed as follows:

$$\begin{matrix}\begin{matrix}Productivity \\ Savings of EDR\end{matrix} = [ ( \# of OGC * OGC Value Added * \\ OGC Net ) + \\ ( \# of Executive * \\ Executive Value Added * \\ Executive Net ) + \\ ( \# of Others * Others Value Added * \\ Others Net ) ] * \\ Avg . number of hours worked per \\ year\end{matrix} \qquad ( 1 )$$

Using the productivity rate and other values provided herein, for the example scenario, Equation (1) can be expressed as:

$$\begin{matrix}\begin{matrix}Productivity \\ Savings of EDR\end{matrix} = [ ( 1 * 200 * 0 \% ) + ( 10 * 300 * 0.5 \% ) + \\ ( 89 * 40 * 0 \% ) ] * 2000 \\ = [ ( 0 ) + ( 15 ) + ( 0 ) ] * 2000 \\ = \$30 , 000 of productivity savings due to \\ decreased time distraction of \\ employees with respect to litigation \\ matters , because of EDR .\end{matrix}$$

A third direct cost 220 can include savings from reduced reserves 414, which can be based on the costs and risks that can be considered in establishing a litigation contingency reserve in accordance with SFAS 5, SFAS 12, for example, and/or the impact of a proposed dispute resolution or portfolio management strategy on the reserve. Accordingly, determining reserve savings 414 can be based on an amount reserved for the dispute contingency cases; an amount of excess reserves (e.g., an amount above a minimum percentage kept on hand); a “hurdle rate” for return on investment opportunities (Weighted Average Cost of Capital); and, revenues per year (based on 10K data).

For the example provided herein with respect to implementing EDR, the reserves savings determination 414 can be based on an example in which there may be an amount of reserves for litigation cases equal to $1,000,000, an excess reserve equal to twenty-percent or $200,000, and a hurdle rate for return on investment opportunities of ten percent. Based on such example numbers, the reserve savings can thus be computed as follows:
Reserve savings=(Excess dollars of reserves*Hurdle rate), and, (3)
using the data provided herein,
Reserve savings=($200,000*10%)=$20,000 in reserve savings

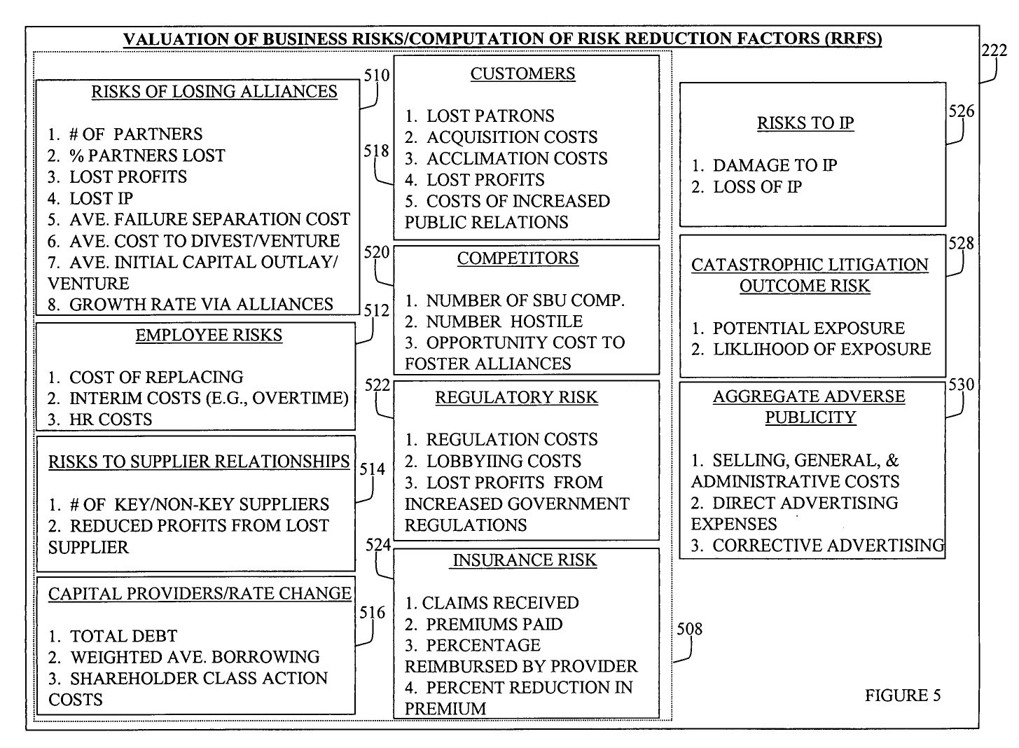

The second tier 222 of the two-tiered valuation 218 of the disclosed model 110 includes a profile of dispute-related business risks 222. Accordingly, the model 110 can include and/or identify relevant categories of business risk 222 and establish an evaluation criteria that can be applied to quantify the financial and economic consequences of risks. Some of these business risks 222 are illustrated in FIG. 5 and can be generally described as: (i) business relationship risks 508; (ii) risks to intellectual property and other assets 526; (iii) catastrophic litigation outcome risk 528; and (iv) aggregate adverse publicity 530.

One embodiment of the model 110, as illustrated, is based on certain presumptions that good business relationships engender trust and reduce friction costs while promoting marketplace goodwill and reputation. Management and conduct of dispute resolution frequently present risks to valuable business relations. These risks can often be measured directly in terms of friction costs resulting from soured relationships that can adversely impact revenues and costs. These risks also involve aggregate adverse publicity in the marketplace. Significant relationship risks can include alliances, employees, suppliers, capital providers, customers, competitors and government regulators. A given dispute or class of disputes can impact one or more of these relationships to an extent that warrants consideration in the development and implementation of business strategy.

Accordingly, and with reference to the aforementioned presumptions and FIG. 5, business relationship risks 508 can further include an alliance relationship risk 510 which can measure risk associated with losing business opportunities resulting from litigation against and/or impacting Joint Venture alliances and partnerships. An alliance relationship risk savings 510 can be based on total number of joint venture/merger & acquisition (JV/M&A) partners, percentage of JV/M&A partners lost, percentage of lost JV/M&A partners regained, amount of lost profits from lost JV/M&A partners, amount of lost intellectual assets portfolio from failed JV/M&As, average alliance failure separation costs, average cost to divest per venture, average initial capital outlay per venture, and growth rate achieved through synergies of alliances.

For example, for a situation in where there may be one-hundred total alliances, the data of Table 2 can be provided:

TABLE 2

| | Before | After | Net |
|---|---|---|---|
| Percentage of Alliances lost per year | 10 | 10 | |
| Percentage of Alliances regained per year | 80 | 100 | 20 |
| Net Alliances lost (Based on 100 alliances) | 2 | 0 | (2) |

Further, based on an initial capital outlay per venture of $1000.00 before and after EDR, and an alliance failure divestiture cost per net alliance lost of $500.00, the total alliance failure costs per net alliance lost are $1500.00. Based on two alliances lost (e.g., from Table 2) before EDR, and zero alliances lost after EDR, the total alliance failure costs before EDR are $3000.00, and the total alliance costs after EDR are 0, resulting in an alliance costs savings of $3000.00.

Such determination can thus be expressed more generally as:
Alliance failure costs savings=Before EDR [(Net alliances lost)*(Initial capital outlay per venture+Alliance failure divestiture costs per net alliances lost)]−After EDR [(Net alliances lost)*(Initial capital outlay per venture+Alliance failure divestiture costs per net alliances lost)] (4)
where Net alliances lost (Before/After)=(Total alliances)*(% of alliances lost/yr)*(1−% of alliances regained/yr)
thereby reducing Equation (4) (in this example) to:

$$\begin{matrix}= Before EDR [ ( 100 * 10 \% * 80 \% ) * ( 1 - 20 \% ) * \\ ( 1 , 000 + 500 ) - \\ After EDR [ ( 100 * 10 \% * 100 \% ) * ( 1 - 100 \% ) * \\ ( 1000 + 500 ) ] , or , \\ = Before EDR [ ( 3000 ) ] - After EDR [ ( 0 ) ] \\ = \$3 , 000 in alliance failure cost savings\end{matrix}$$

Further, lost profits from alliance synergy can be expressed as provided in Table 3, and in a sample embodiment, the lost reduction savings per year can be extrapolated for an additional number of years (e.g., eight years), and the savings for each year can be discounted to the present value using a discount rate.

TABLE 3

| | Before | After | Net |
|---|---|---|---|
| Lost profits from lost alliance synergy per year | $1,000 | $500 | $500 |
| Lost intellectual asset portfolio per year | $1,000 | $500 | $500 |
| Total lost profit reduction savings per year | | | $1,000 |

Referring back to FIG. 5, another business relationship risk 508 includes employee relationship risks 512 which consider that management and resolution of disputes can have adverse consequences in relationships with employees. A determination of employee relationship risk savings 512 due to the proposed business decision (e.g., EDR) can be based on costs of replacing employees (measured per employee, based on recruiting costs, lost network of resources, training, and/or increase to market salary), costs associated with time for new employees to adjust, increased interim costs (increased outsourcing, overtime pay, etc.), employee attrition as a percentage of total employees, key human resource disputes per year, non-key human resource disputes per year, human resources costs per key HR dispute, and human resources costs per non-key HR dispute (before and after EDR implementation)

For example, given a total number of one-hundred employees, a cost to replace an employee can be estimated as a loss of $1,000 each for the network of resources, training, increase to market salary, time to adjust, increase cost in interim, and recruiting costs, thereby providing a total replacement cost of $6,000. Further, in the example, an employee attrition rate of five percent before EDR, and four percent after EDR, can allow for a determination of employee replacement cost savings.
Employee Replacement Cost Savings=Before EDR (Total number of employees*Employee Attrition Percentage*Total replacement costs)−After EDR (Total number of employees*Employee Attrition Percentage*Total replacement costs) (5),
thereby reducing Equation (5) in this example to:

$$\begin{matrix}= Before EDR ( 100 * 5.0 \% * 6 , 000 ) - After EDR \\ ( 100 * 4.0 \% * 6 , 000 ) \\ = Before EDR ( 30 , 000 ) - After EDR ( 24 , 000 ) \\ = \$6 , 000 in employee replacement cost savings\end{matrix}$$

Costs due to human resource disputes can further be determined by evaluating data such as that provided in Table 4.

TABLE 4

| | Before | After | Net |
|---|---|---|---|
| Number of Key HR disputes per year | 10 | 5 | (5) |
| Average HR cost per dispute (key) | $1,000 | $1,000 | 0 |
| Number of Non Key HR disputes per year | 100 | 50 | (50) |
| Average HR cost per dispute (non-key) | $100 | $100 | 0 |

Accordingly,

$$\begin{matrix}\begin{matrix}\begin{matrix}Human Resource \\ Dispute Savings\end{matrix} = [ Key disputes \text{:} Before EDR \\ ( Number of HR disputes * \\ Average cost per dispute ) - \\ After EDR ( Number of HR disputes * \\ Average cost per dispute ) ] + \\ [ Non \text{-} Key disputes \text{:} Before EDR \\ ( Number of HR disputes * \\ Average cost per dispute ) - \\ After EDR ( Number of HR disputes * \\ Average cost per dispute ) ] , \\ thereby reducing Equation ( 6 ) for \\ the example , to \\ = [ Key disputes \text{:} Before EDR ( 10 * 1 , 000 ) - \\ After EDR ( 5 * 1 , 000 ) ] + \\ [ Non \text{-} Key disputes \text{:} Before EDR \\ ( 100 * 100 ) - \\ After EDR ( 50 * 100 ) \\ = Key disputes ( 5 , 000 ) + \\ Non \text{-} Key disputes ( 5 , 000 ) \\ = \$10 , 000 in human resource dispute \\ savings\end{matrix} & ( 6 ) \\ \begin{matrix}\begin{matrix}\begin{matrix}\begin{matrix}Accordingly , a \\ total employee\end{matrix} \\ risk reduction\end{matrix} \\ savings\end{matrix} = Replacement cost savings + \\ human resource dispute savings \\ where Equation ( 7 ) can be reduced \\ in the example herein to \text{:} \\ = 6 , 000 + 10 , 000 \\ = \$16 , 000 in employee risk \\ reduction savings per year based \\ on EDR .\end{matrix} & ( 7 )\end{matrix}$$

With reference to FIG. 5, supplier relationship risks 514 can include costs associated with increased risks of damage to relationships with suppliers of goods, services, and capital. Determining supplier relationship risk savings can be based on a number of suppliers, key and non-key suppliers (e.g., percentage of suppliers lost/recouped (e.g., per year), and costs of replacing a supplier (one-time costs) which can include compatibility of systems, costs to smooth friction of operating with a new supplier, costs of increased public relations), reduced profits due to a lost supplier (annual costs) which can include down-time to achieve desired quality of product, costs of increased produce delivery time, and lost profits from un-replaced supplier.

As an example of a supplier risk reduction determination, consider that a total number of five-hundred suppliers is considered, where twenty percent of such suppliers are deemed “key” suppliers, and eighty percent are considered non-key suppliers. Further consider Table 5 data with respect to key suppliers.

TABLE 5

| | Before | After | Net |
|---|---|---|---|
| Percentage of suppliers lost per year | 10% | 5% | (5%) |
| Percentage of suppliers replaced per year | 100% | 100% | 0% |
| Number of suppliers replaced | 10 | 5 | (5) |
| Number of suppliers lost | 0 | 0 | 0 |
| Consistent systems of order processing | $1000 | $1000 | |
| Increased costs to find a new supplier | $500 | $500 | |
| Total opportunity cost to find a new supplier | $1500 | $1500 | |

Accordingly,
Opportunity costs savings to find a new supplier=Before EDR (Number of suppliers replaced*Opportunity cost to find a new supplier)−After EDR (Number of suppliers replaced*Opportunity cost to find a new supplier) (8)
which reduces in the present example to:

$$\begin{matrix}= Before EDR ( 10 * 1 , 500 ) - After EDR ( 5 * 1 , 500 ) \\ = Before EDR ( 15 , 000 ) - After EDR ( 7 , 500 ) \\ = \$7 , 500 in opportunity costs savings to find a new supplier\end{matrix}$$

Determinations can further be made for non-key suppliers, using a methodology that can be substantially the same; and, thereafter, the savings from key and non-key suppliers can be aggregated (e.g., summation, weighted sum, etc.). Further, lost profits from a supplier change can be estimated based on a cost of $1,000 for down time to achieve desired quality and $1,000 for increased product delivery time, to provide a total lost profits from supplier change of $2,000. Furthermore, un-replaced supplier lost profits can be caused by potential discontinued operations and loss of materials, which can be estimated at $5,000. Accordingly,
Lost profit reductions savings=Before EDR[(Number of suppliers replaced*Total lost profits from supplier change)+(Number of suppliers lost*Lost profits from un-replaced suppliers)]−After EDR [(Number of suppliers replaced*Total lost profits from supplier change)+(Number of suppliers lost*lost profits from un-replaced suppliers)], (9)
which reduces in the present example to:

$$\begin{matrix}= Before EDR [ ( 10 * 2 , 000 ) + ( 0 * 5 , 000 ) ] - \\ After EDR [ ( 5 * 2 , 000 ) + ( 0 * 5 , 000 ) \\ = Before EDR [ ( 20 , 000 ) ] - After EDR [ ( 10 , 000 ) ] \\ = \$10 , 000 in lost profit reduction savings\end{matrix}$$

Such lost profit reduction savings per year can be extrapolated each year for an additional number of years (e.g., eight years). The savings for each year can then be discounted to the present value using a discount rate, where a weighted average cost of capital can be used as a benchmark to set the discount rate. Furthermore,
Total supplier risk reduction savings=Opportunity cost savings to find a new supplier+Lost profit savings (10)
where Equation (10) in the present example reduces to:

$$\begin{matrix} = \$7 , 500 + \$10 , 000 \\ = \$17 , 500 in supplier risk reduction savings\end{matrix}$$

With reference to FIG. 5, capital provider relationship risk 516 can include risks of adversely affecting borrowing rates and shareholder confidence. Determining capital provider relationship risk 516 can be based on total debt borrowings per year, weighted average borrowing rate, shareholder class action costs, and institutional investor dispute costs.

One example of determining capital provider risk 516 can include a total debt borrowings per year of $1,000,000, with a weighted average cost of debt (WACD) of 5.0% pre-EDR, and 4.0% post-EDR. Based on these example figures,

Debt in borrowed savings=Before EDR (Total debt borrowings per year*WACD)−After EDR (Total debt borrowings per year*WACD),

$$\begin{matrix}= Before EDR ( 1 , 000 , 000 * 5.0 \% ) - After EDR \\ ( 1 , 000 , 000 * 4.0 \% ) \\ = Before EDR ( 50 , 000 ) - After EDR ( 40 , 000 ) \\ = \$10 , 000 in debt borrowing savings\end{matrix} \qquad ( 11 )$$

Further, where example shareholder class action costs and institutional investor dispute costs are each $1,000,000 and $500,000, pre and post-EDR, respectively, yielding net savings for each of $500,00,

$$\begin{matrix}\begin{matrix}Shareholder \\ cost savings\end{matrix} = \text{Shareholder class action costs net savings} + & ( 12 ) \\ \text{Institutional investor dipute cost net} & \\ \text{savings,} & \\ = \$500 , 000 + \$500 , 000 & \\ = \$1 , 000 , 000 \text{in investor risk reduction} & \\ \text{savings} & \\ Similarly , & \\ \begin{matrix}\text{Capital provider} \\ \text{risk reduction savings}\end{matrix} = \text{Debt borrowing savings} + & ( 13 ) \\ \text{Investor risk reduction savings,} & \\ = \$10 , 000 + \$1 , 000 , 000 & \\ = \$1 , 010 , 000 \text{in capital provider} & \\ \text{risk reduction savings} & \end{matrix}$$

Referring again to FIG. 5, customer relationship risks 518 consider that dispute management and resolution involves risks of loss of patronage by customers resulting in an adverse customer turnover rate from damaged perceptions and relationships. Determining customer relationship risk savings can be based on total number of business-to-business (B2B) customers, percentage of key and non-key B2B customers (percentage of customers lost per year, percentage of customers recouped per year, acquisition costs per new customers (compatibility of systems, acclimation costs, costs of increased public relations/discounts, and lost profits from lost customers).

For example, given a total number of B2B customers of one hundred, a percentage of key customers of twenty percent, a percentage of non-key customers of eighty percent, the data of Table 6, and with further considerations relating to acquisition costs per new customer (e.g., compatibility of systems, $1,000; new customer acclimation, $1,000; new customer public relations, $1,000; and, hence, total acquisition costs per customer $3,000),

$$\begin{matrix}\begin{matrix}Acquisition \\ Costs\end{matrix} = Before EDR ( Total number of B2B \\ customers * Percentage of customers lost \\ per year * Percentage of lost customers \\ re \text{-} couped * Total acquisition costs per \\ customer ) - \\ After EDR ( Total number of B2B \\ customers * Percentage of customers lost \\ per year * Percentage of lost customers \\ re \text{-} couped * Total acquisition costs per \\ customer ) , \\ = Before EDR ( 20 * 20 \% * 75 \% * 3 , 000 ) - \\ After EDR ( 20 * 10 \% * 100 \% * 3 , 000 ) \\ = Before EDR ( 9 , 000 ) - After EDR ( 6 , 000 ) \\ = \$3 , 000 in acquisition cost savings per year\end{matrix} \qquad ( 14 )$$

TABLE 6

| | Before | After | Net |
|---|---|---|---|
| Total number of B2B customers | 20 | 20 | 0 |
| Percentage of customers lost per year | 20 | 10 | (10) |
| Percentage of lost customers re-couped | 75 | 100 | 25 |
| Number of customers re-couped per year | 3 | 2 | (1) |
| Net customers lost per year | 1 | 0 | (1) |

Additionally, when lost profits per key customer lost per year are estimated to be $1,000,

$$\begin{matrix}\begin{matrix}Lost \\ Profit\end{matrix} = Before EDR ( Lost profits per key customer lost \\ per year * Net key customers lost per year ) - \\ After EDR ( Lost profits per key customer lost \\ per year * Net key customers lost per year ) , \\ = Before EDR ( 1 , 000 * 1 ) - After EDR ( 1 , 000 * 0 ) \\ = Before EDR ( 1000 ) - After EDR ( 0 ) \\ = \$1 , 000 in lost profit reduction savings\end{matrix} \qquad ( 15 )$$

It can be understood that similar determinations can be made for non-key customers, with the results from key and non-key customers aggregated to providing a resulting savings. Additionally, the lost profit reduction savings per year can be extrapolated for an additional number of years (e.g., eight years), with the savings discounted to the present value using a discount rate, where the weighted average cost of capital can be used as a benchmark to set the discount rate.

With continued reference to FIG. 5, competitor relationship risk 520 considers risks of hostile relationships with competitors leading to litigation, regulatory intervention, unfriendly takeovers, etc. Determining competitor relationship risk savings can be based on a number of SBU competitors, a number of hostile relationships, and opportunity cost of fostering alliances.

For example, given a one-hundred total number of SBU competitors, an opportunity cost of fostering alliances of $1,000, and a percentage of hostile relationships of five percent pre-EDR and four percent post-EDR (e.g., yielding a number of hostile relationships of 5 and 4, respectively),

$$\begin{matrix}\begin{matrix}Competitor \\ Risk\end{matrix} = Before EDR ( Total number of SBU \\ competitors * Opportunity cost of fostering \\ alliances * Percentage of hotile relationships ) - \\ After EDR ( Total number of SBU \\ competitors * Opportunity cost of fostering \\ alliances * Percentage of hotile relationships ) , \\ = Before EDR ( 100 * 1 , 000 * 5 \% ) - \\ After EDR ( 100 * 1 , 000 * 4 \% ) \\ = Before EDR ( 5 , 000 ) - After EDR ( 4 , 000 ) \\ = \$1 , 000 in competitor risk reduction savings\end{matrix} \qquad ( 16 )$$

Referring again to FIG. 5, regulatory risk 522 considers that litigation also presents a risk of adversarial, non-productive relationships with government regulators. Determining regulatory risk savings can be based on regulation costs, lobbying costs, and lost profits from increased government regulations.

For example, given sample data as provided in Table 7, a lost profit reduction savings per year ($500) can be extrapolated each year for an additional number of years (e.g., eight years), with the savings discounted to present value as provided herein, for example.

Accordingly,

$$\begin{matrix}\begin{matrix}Regulatory \\ Risk\end{matrix} = Before EDR ( Regulation costs + \\ Lobbying costs + Lost profits ) - \\ After EDR ( Regulation costs + \\ Lobbying costs + Lost profits ) , \\ = Before EDR ( 1 , 000 + 1 , 000 + 1 , 000 ) - \\ After EDR ( 500 + 500 + 500 ) \\ = Before EDR ( 3 , 000 ) - After EDR ( 1 , 500 ) \\ = \$1 , 500 in regulatory risk reduction savings\end{matrix} \qquad ( 17 )$$

TABLE 7

| | Before | After | Net |
|---|---|---|---|
| Regulation costs | $1,000 | $500 | ($500) |
| Lobbying costs | $1,000 | $500 | ($500) |
| Lost profits | $1,000 | $500 | ($500) |

Once again with reference to FIG. 5, insurance risk 524 considers the risk of bearing a higher insurance burden from coverage disputes, premium costs, etc. Determining insurance risk savings can be based on insurance claims receivable per year, total insurance premium paid per year, percentage reimbursed by insurance providers, percentage of captive and non-captive insurance, and percentage of reduction in premium for captive and non-captive insurance.

For example, if for disputes, insurance claims receivable per year are $2,000,000, and a percentage reimbursed by insurance providers is fifty percent before EDR, and forty percent after EDR,

$$\begin{matrix}\begin{matrix}Dispute related \\ insurance savings\end{matrix} = Before EDR ( Insurance claims \\ receivable per year * \% reimbursed \\ by insurance providers ) - \\ After EDR ( Insurance claims \\ receivable per year * \% reimbursed \\ by insurance providers ) , \\ = Before EDR ( 2 , 000 , 000 * 50 \% ) - \\ After EDR ( 2 , 000 , 000 * 40 \% ) \\ = Before EDR ( 1 , 000 , 000 ) - \\ After EDR ( 800 , 000 \\ = \$200 , 000 in dispute related insurance \\ risk reduction savings\end{matrix} \qquad ( 18 )$$

With regard to insurance premiums, given a total insurance premium paid per year of $1,000,00, a percentage of captive insurance of thirty percent, a percentage reduction in captive premium of one percent, a percentage of non-captive insurance of seventy percent, and a percentage reduction in non-captive premium of one percent,

$$\begin{matrix}\begin{matrix}Insurance Premium \\ Risk Reduction\end{matrix} = ( Total insurance premium paid \\ per year * \% of captive insurance * \\ \% reduction in captive premium ) + \\ ( Total insurance premium paid \\ per year * \% of non \text{-} captive \\ insurance * \% reduction in \\ non \text{-} captive premium ) , \\ = ( 1 , 000 , 000 * 30 \% * 1 \% ) + \\ ( 1 , 000 , 000 * 70 \% * 1 \% ) \\ = ( 3 , 000 ) + ( 7 , 000 ) \\ = \$10 , 000 in premium related \\ insurance risk reduction savings\end{matrix} \qquad ( 19 )$$

As FIG. 5 indicates, risks to intellectual property 526 and other assets considers that among the business risks of collateral damage from a dispute is the prospect of damage to or loss of intellectual property or other valuable assets. The disclosed model can thus include and/or consider risks of injury to such assets as a consequence of dispute management and resolution.

Catastrophic litigation outcome risk 528 considers that individual disputes can carry a worst case scenario of catastrophic risk, disastrous litigation, or other outcome that could threaten the firm's ability to continue as a going concern. Determining catastrophic litigation outcome risk savings can be based on catastrophic litigation potential exposure, and/or likelihood of a catastrophic litigation.

For example, consider a catastrophic litigation potential exposure of $1,000,000, and a likelihood of a catastrophic litigation of two percent pre-EDR, and one percent post-EDR,

$$\begin{matrix}\begin{matrix}Catastrophic litigation \\ outcome risk\end{matrix} = Before EDR ( Catastrophic litigation \\ potential exposure * Likelihood of \\ a catastrophic litigation ) - \\ After EDR ( Catastrophic litigation \\ potential exposure * Likelihood of \\ a catastrophic litigation ) , \\ = Before EDR ( 1 , 000 , 000 * 2 \% ) - \\ After EDR ( 1 , 000 , 000 * 1 \% ) \\ = Before EDR ( 20 , 000 ) - \\ After EDR ( 10 , 000 ) \\ = \$10 , 000 in catastrophic litigation \\ outcome risk reduction savings\end{matrix} \qquad ( 20 )$$

With continued reference to FIG. 5, aggregate adverse publicity 530 includes risks associated with unfavorable media publicity/regulatory intervention, etc. Determining aggregate adverse publicity risk savings can be based on selling, general, and administrative expenses (“SG&A) (e.g., 10K data), direct advertising expenses (as a percentage of SG&A) before and after EDR implementation, and corrective advertising expenses (as a percentage of SG&A) before and after EDR implementation.

As an example, of an aggregate adverse publicity risk reduction determination, consider a selling, general & administrative expenses (SG&A) expense of $1,000, and the data of Table 8,

$$\begin{matrix}\begin{matrix}Aggregate adverse \\ publicity risk\end{matrix} = Before EDR [ SG \& A * ( Direct \\ advertising expenses + \\ Corrective advertising expenses ) ] - \\ After [ SG \& A * ( Direct advertising \\ expenses + Corrective advertising \\ expenses ) ] , \\ where Equation ( 21 ) can be reduced to the following \\ based on the example data \text{:} \\ = Before EDR [ \$1 , 000 * ( 3.0 \% + 3.0 \% ) ] - \\ After EDR [ \$1 , 000 * ( 2.0 \% + 2.0 \% ) ] \\ = Before EDR [ ( \$60 ) ] - \\ After EDR [ ( \$40 ) ] \\ = \$20 in aggregate adverse publicity \\ risk reduction savings\end{matrix} \qquad ( 21 )$$

TABLE 8

| | Before | After | Net |
|---|---|---|---|
| Direct advertising expenses | 3.0% | 2.0% | (1.0%) |
| (as a percentage of SG&A) | | | |
| Corrective advertising expenses | 3.0% | 2.0% | (1.0%) |
| (as a percentage of SG&A) | | | |

In some embodiments, further risk reduction factors can include issues related to privacy and/or security, including information technology (IT) security. For example, policies that may be related to privacy issues such as computer password protection, etc., can reduce a risk of system infiltration by unknown and/or undesired individuals, thereby preventing, for example, corruption of data and/or misappropriation of data and/or proprietary information. Further, policies related to document retention, including email retention, etc., can also reduce risks during a litigation. For example, the existence and implementation of a document retention policy by a general counsel's office may allow for certain documents to be retained that may otherwise not have been retained, and for other documents to be destroyed according to the policy, which if retained, may have been detrimental to the litigation. These risks can be valued as provided herein. Accordingly, the implementation of privacy, IT, and/or security policies can provide further value to a general counsel's office.

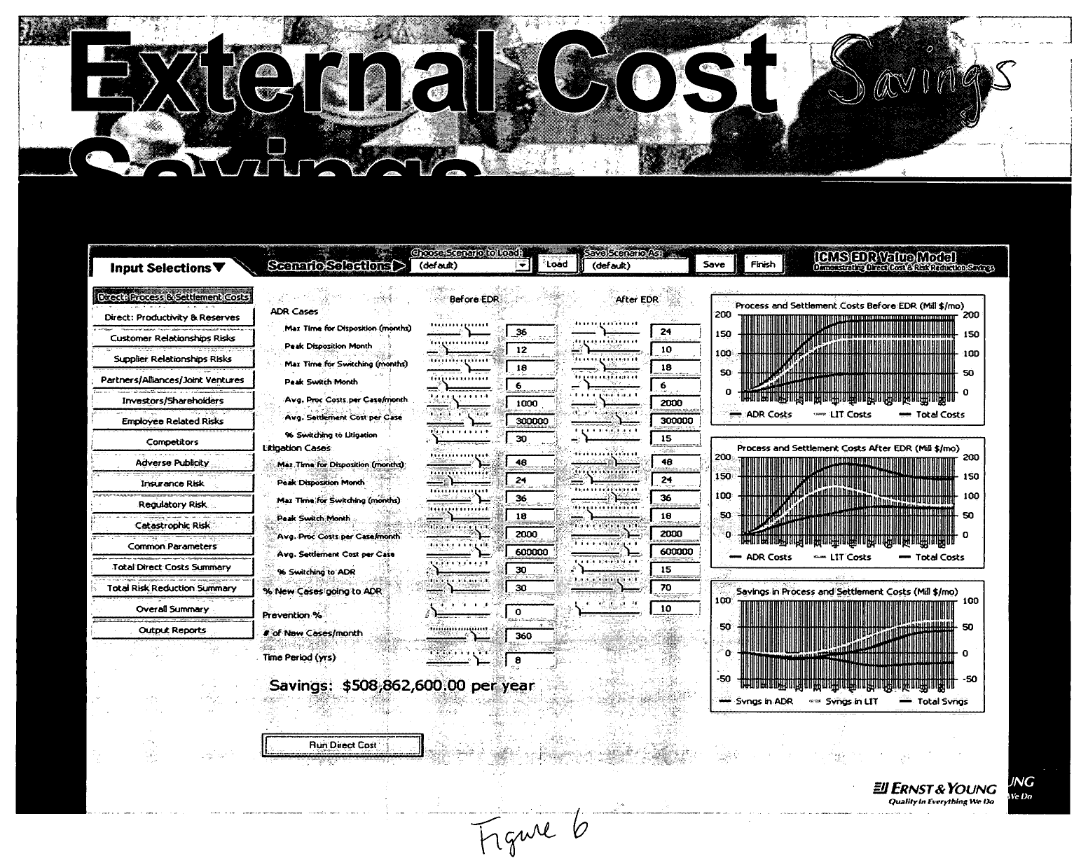

FIG. 6 provides one user interface for the foregoing methods and systems that allows direct cost input selections to be provided by a user or another, where such direct costs are related to process and settlement costs. As FIG. 6 indicates, a multitude of variables related to EDR/ADR cases and Litigation cases (e.g., maximum time for disposition, peak disposition month, maximum time for switching, peak switch month, average process costs per case per month, average settlement cost per case, and percent switching) can be combined with other inputs such as the a percent of new cases going to ADR/EDR, a prevention percentage, a number of new cases per month, and a time period in years, to compute a direct costs savings related to external costs. As shown by FIG. 6, graphs and plots can be provided to compare the before and after EDR costs.

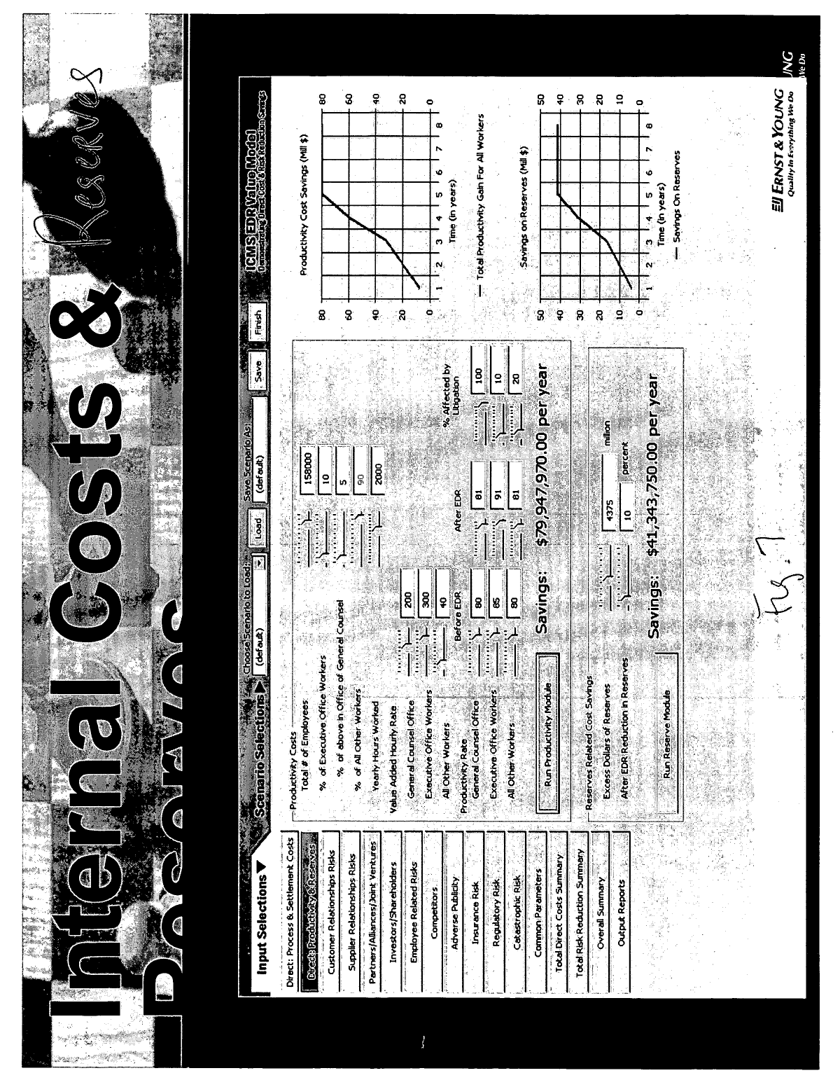

FIG. 7 presents a user interface for providing direct costs inputs related to productivity and reserves. As shown in FIG. 7, productivity costs can be based on a total number of employees, a percentage of executive office workers, a percentage of general counsel employees, yearly hours worked per employee, and hourly rates assigned respectively to general counsel employees, executive office workers, and others. The FIG. 7 embodiment further considers productivity rates that, as provided herein, can be adjusted for before and after EDR implementations. Reserves can further be modeled as a percentage of excess dollars of reserves.

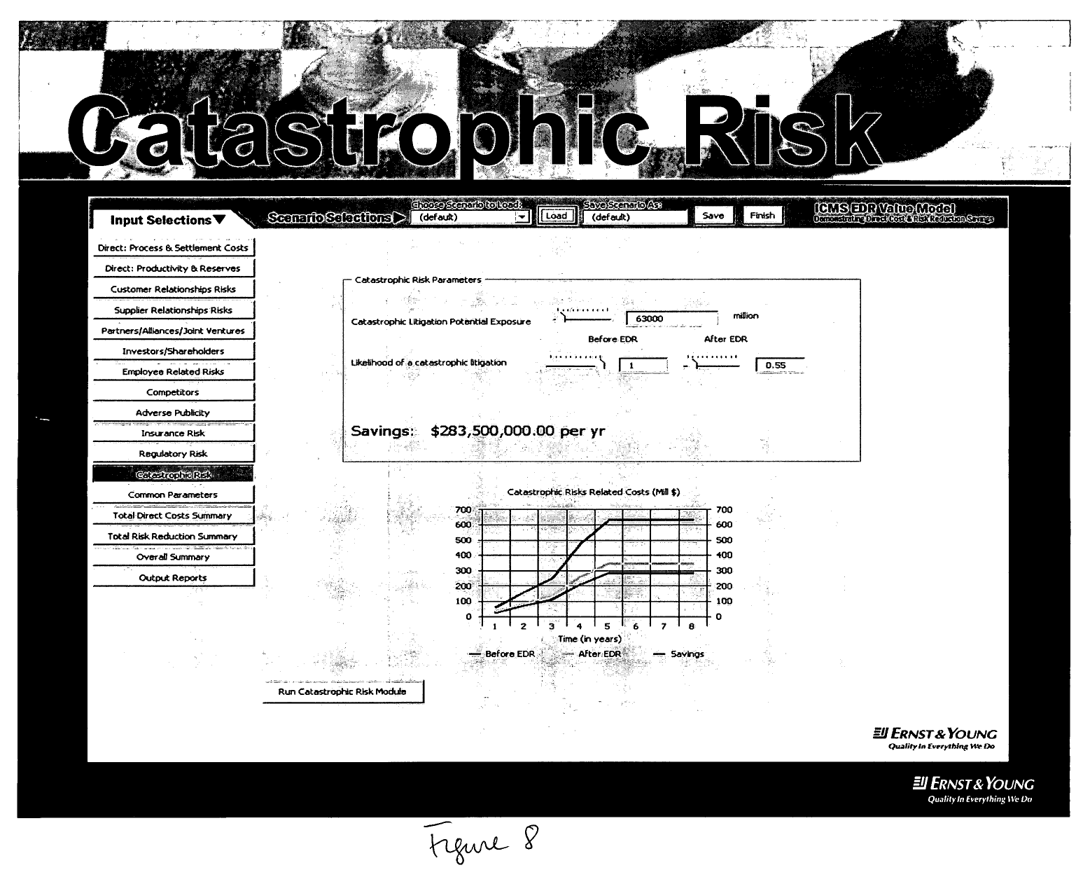

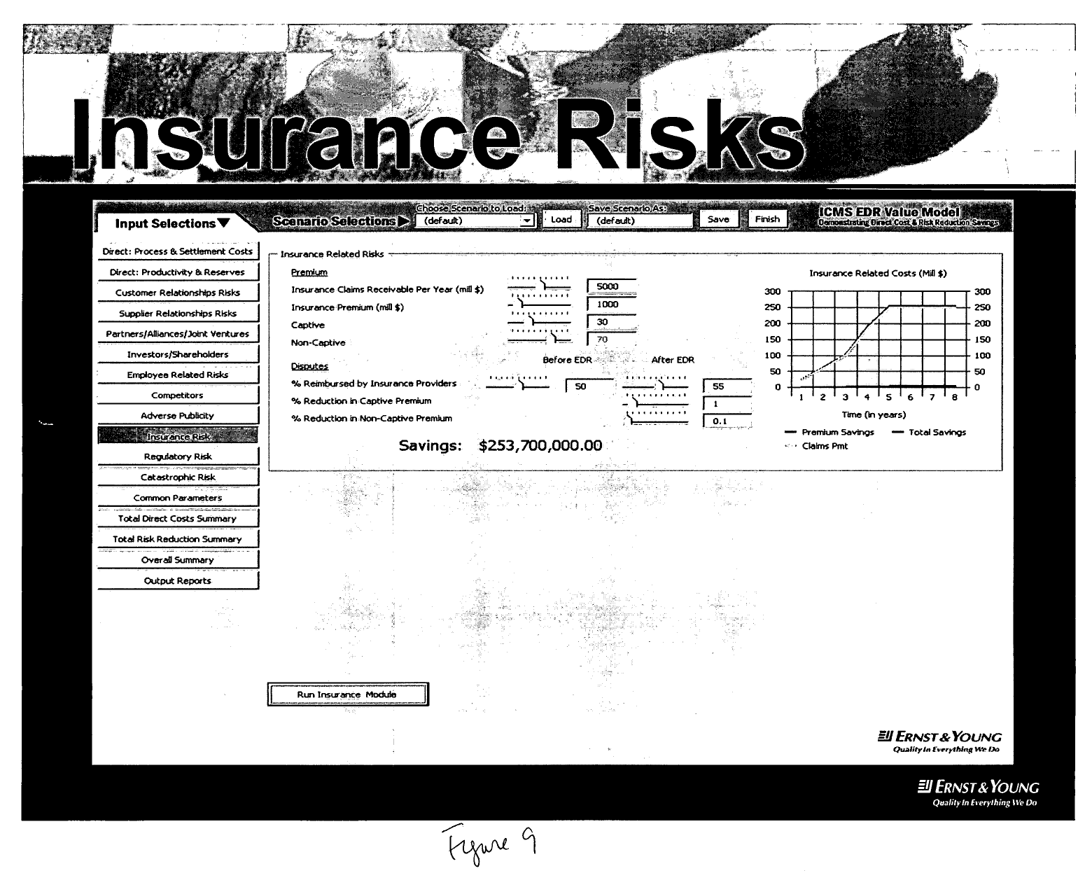

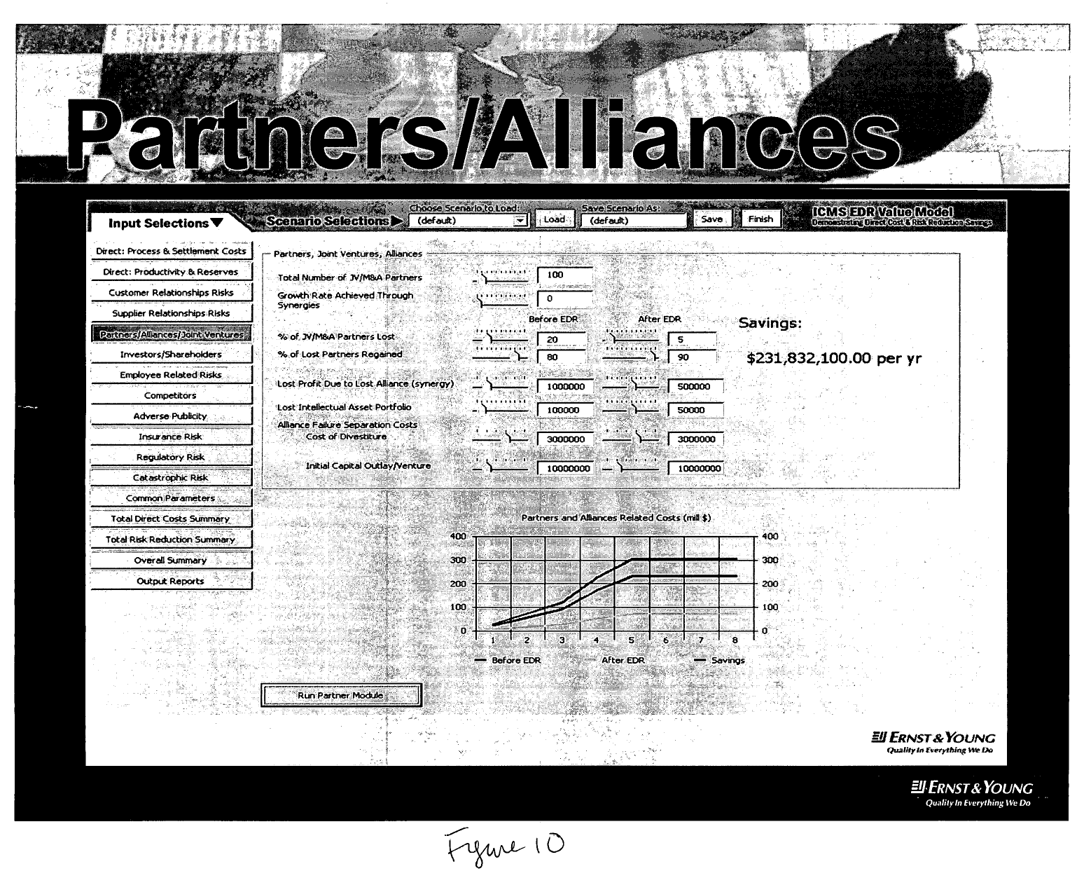

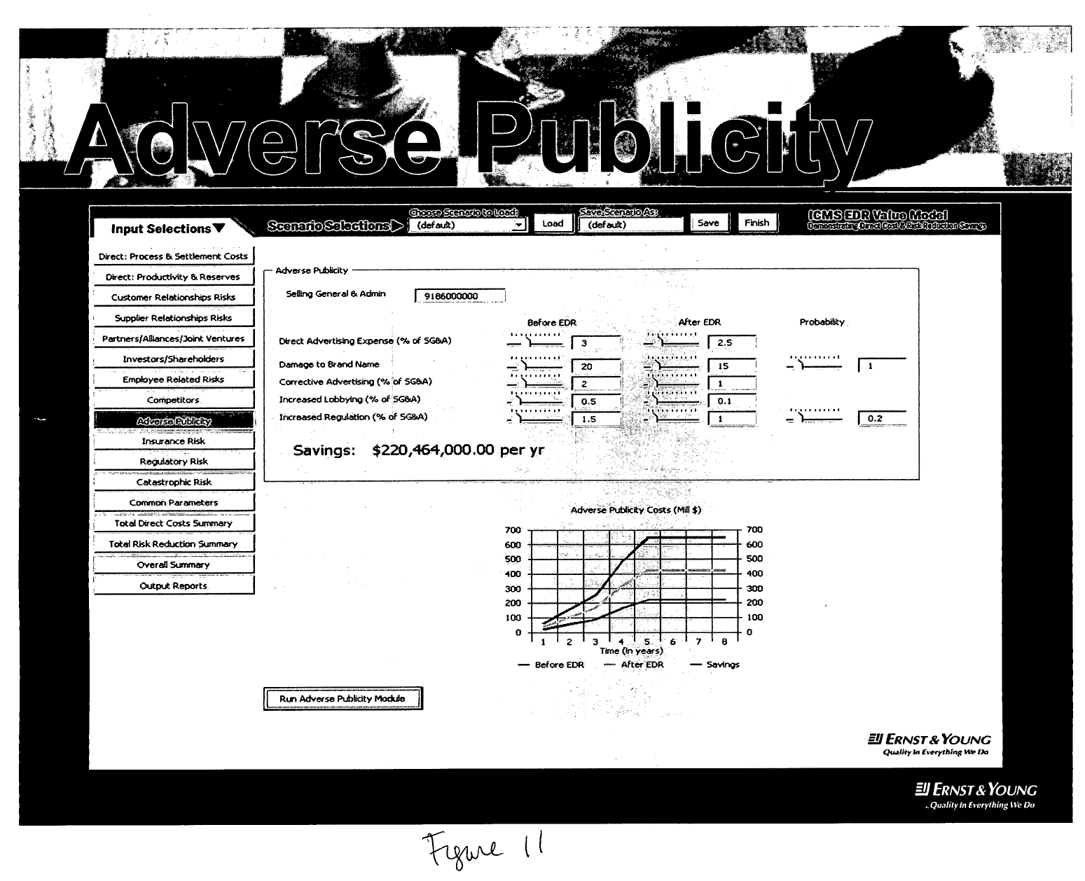

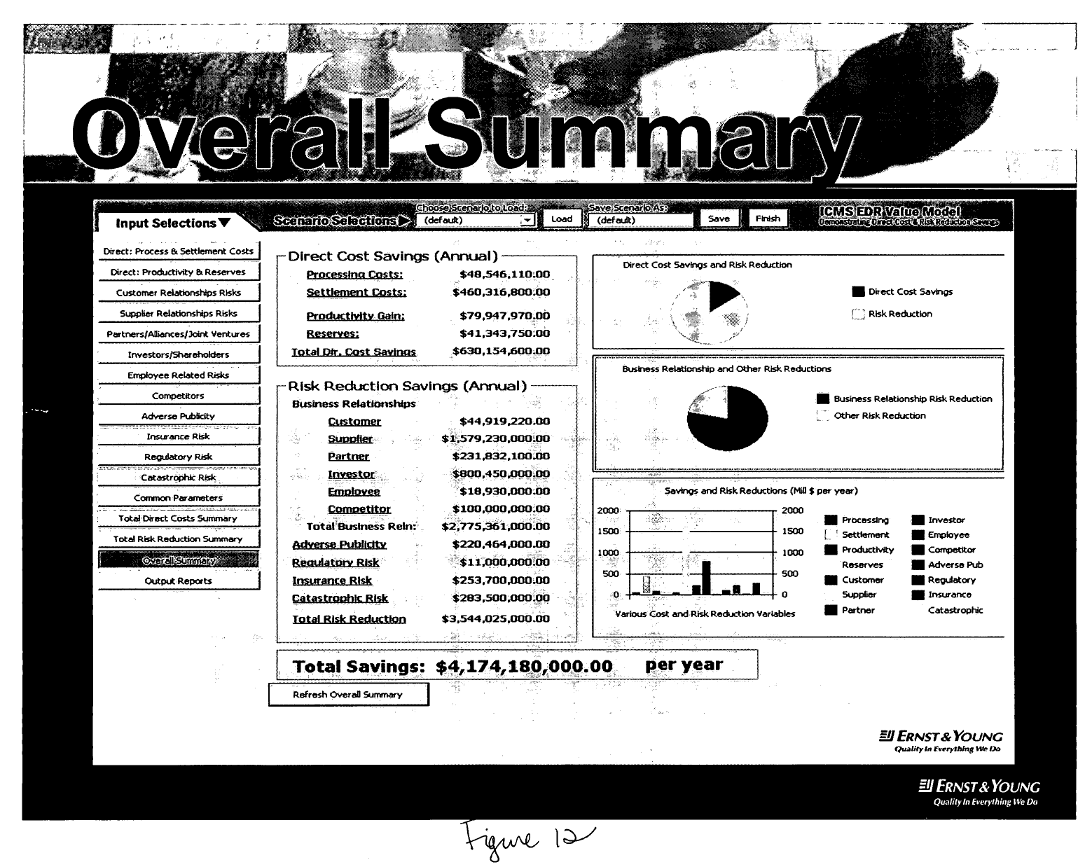

FIG. 8 provides an interface for computing catastrophic risk, FIG. 9 presents an interface for insurance risks, FIG. 10 shows one interface for assessing partner/alliance business relationship risk, and FIG. 11 provides an interface for adverse publicity risk valuation. As demonstrated in FIGS. 6-11, one embodiment of the disclosed methods and systems can thus provide for a selectable menu with regard to the direct costs and the risk valuations to allow a user or another to select and/or modify model parameters related to the various model aspects of interest, where FIGS. 6-11 are merely illustrative of some of the selectable options in one embodiment. FIG. 12 provides an output for one embodiment that provides a summary of the various direct cost savings and the risk reduction savings.

As provided herein, a “cost” as in a “direct cost” can be understood generally to be a measure which can have a positive or negative value, and a “reduction” as in a “risk reduction” can be understood to be a measure which can have a positive or negative value (e.g., an increase or a decrease). Accordingly, the use of the terms “cost” and “reduction” are merely for convenience and illustration.

What has thus been described are methods, systems, and processor instructions to determine a first direct cost associated with at least a partial implementation of a business decision, the first direct cost including at least one of productivity gains and losses, determine a second direct cost based on a non-implementation of the business decision, the second direct cost based on the productivity gains and losses, determine a first risk reduction associated with at least a partial implementation of the business decision, the first risk reduction based on a business relationship risk(s), determine a second risk reduction associated with a non-implementation of the business decision, the second risk reduction based on the business relationship risk(s), and, associate the business decision with a value, the value corresponding to a sum between differences of: (i) the first direct cost and the second direct cost, and, (ii) the first risk reduction and the second risk reduction.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. For example, although the disclosed methods and systems included embodiments related to general counsel, other entities can be valuated similarly. Further, although the example business decision include EDR/ADR, the disclosed methods and systems can further be applied to other business decisions.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

1. A processor program product disposed on a processor-readable medium, the processor program product having processor instructions for causing at least one processor to:
determine a first direct cost associated with at least a partial implementation of a business decision, the first direct cost including at least one of productivity gains and losses,
determine a second direct cost based on a non-implementation of the business decision, the second direct cost based on the at least one of productivity gains and losses,
determine a first risk reduction associated with at least a partial implementation of the business decision, the first risk reduction based on at least one business relationship risk,
determine a second risk reduction associated with a non-implementation of the business decision, the second risk reduction based on the at least one business relationship risk, and,
associate the business decision with a value, the value corresponding to a sum between:
(i) a difference between the first direct cost and the second direct cost, and,
(ii) a difference between the first risk reduction and the second risk reduction.

2. The processor program product of claim 1, where the business decision includes at least one of alternative dispute resolution (ADR) and early dispute resolution (EDR).

3. The processor program product of claim 1, where the at least one of productivity gains and losses includes at least one of: a cost of diverted time, a cost of diverted resources, a value of diverted time, a value of diverted resources, and a productivity rate.

4. The processor program product of claim 1, where the first direct cost and the second direct cost includes at least one process and settlement cost.

5. The processor program product of claim 4, where the at least one process and settlement cost includes at least one of: expenditures to third parties, expenditures to experts, expenditures to consultants, internal administrative costs, a number of new cases, actual costs of using alternatives, estimated costs of using alternatives, actual costs of using prevention, and estimated costs of using prevention.

6. The processor program product of claim 4, where the at least one process and settlement cost is based on at least one of: maximum time for disposition of an EDR case, peak disposition month for an EDR case, maximum time for switching between litigation and EDR, peak switch month for switching between litigation and EDR, average process costs per EDR case per month, average settlement cost per EDR case, percent of cases switching from EDR to ligitation, maximum time for disposition of a litigation case, peak disposition month for a litigation case, maximum time for switching between EDR and litigation, peak switch month for switching between EDR and litigation, average process costs per litigation case per month, average settlement cost per litigation case, and percent of cases switching from litigation to EDR.

7. The processor product of claim 4, where the at least one process and settlement cost is based on a phased-implementation of the business decision.

8. The processor program product of claim 1, where the first direct cost and the second direct cost includes at least one reserve savings.

9. The processor program product of claim 8, where the at least one reserve savings includes at least one of: an amount reserved for contingency cases, an amount of excess reserves, a hurdle rate, and an annual revenue.

10. The processor program product of claim 1, where the at least one business relationship risk includes at least one of: a risk of losing an alliance, an employee risk, a supplier relationship risk, a capital provider/rate change risk, a customer risk, a competitor risk, a regulatory risk, and an insurance risk.

11. The processor program product of claim 10, where the risk of losing an alliance is based on at least one of: a number of partners, a percentage of partners lost, lost profits, lost intellectual property, average failure separation cost, average cost to divest per venture, average initial capital outlay per venture, and growth rate via alliances.

12. The processor program product of claim 10, where the employee risk is based on at least one of: a cost of replacing an employee, at least one interim cost, and at least one human resource cost.

13. The processor program product of claim 10, where the supplier relationship risk is based on at least one of: a number of key suppliers, a number of non-key suppliers, and a reduced profit from a lost supplier.

14. The processor program product of claim 10, where the capital provider/rate change risk is based on a total debt, a weighted average borrowing, and at least one shareholder class action cost.

15. The processor program product of claim 10, where the customer risk is based on lost patrons, acquisition costs, acclimation costs, lost profits, and costs of increased public relations.

16. The processor program product of claim 10, where the competitor risk is based on a number of SBU competitors, a number of hostile relationships, and an opportunity cost of fostering alliances.

17. The processor program product of claim 10, where the regulatory risk is based on a regulation cost, a lobbying cost, and lost profits from increased government regulations.

18. The processor program product of claim 10, where the insurance risk is based on claims received, premiums paid, percentage reimbursed by a provider, and a percent reduction in premium.

19. The processor program product of claim 1, where the first risk reduction and the second risk reduction are based on at least one intellectual property risk.

20. The processor program product of claim 19, where the at least one intellectual property risk includes at least one of: damage to intellectual property and loss of intellectual property.

21. The processor program product of claim 1, where the first risk reduction and the second risk reduction are based on at least one litigation outcome risk.

22. The processor program product of claim 21, where the at least one litigation outcome risk includes at least one of: a potential exposure risk and a likelihood of exposure risk.

23. The processor program product of claim 1, where the first risk reduction and the second risk reduction are based on at least one adverse publicity risk.

24. The processor program product of claim 23, where the at least one adverse publicity risk includes at least one of: damage to brand name, direct advertising expenses, corrective advertising expenses, selling costs, general costs, and administrative costs, increased lobbying, and increased regulation.

25. A method, comprising:
determining a first direct cost associated with at least a partial implementation of a business decision, the first direct cost including at least one of productivity gains and losses,
determining a second direct cost based on a non-implementation of the business decision, the second direct cost based on the at least one of productivity gains and losses,
determining a first risk reduction associated with at least a partial implementation of the business decision, the first risk reduction based on at least one business relationship risk,
determining a second risk reduction associated with a non-implementation of the business decision, the second risk reduction based on the at least one business relationship risk, and,
associating the business decision with a value, the value corresponding to a sum between:
(i) a difference between the first direct cost and the second direct cost, and,
(ii) a difference between the first risk reduction and the second risk reduction.

26. The method of claim 25, where the business decision includes at least one of alternative dispute resolution (ADR) and early dispute resolution (EDR).

27. The methd of claim 25, where the at least one of productivity gains and losses includes at least one of: a cost of diverted time, a cost of diverted resources, a value of diverted time, a value of diverted resources, and a productivity rate.

28. The method of claim 25, where the first direct cost and the second direct cost includes at least one process and settlement cost.

29. The method of claim 28, where the at least one process and settlement cost includes at least one of: expenditures to third parties, expenditures to experts, expenditures to consultants, internal administrative costs, a number of new cases, actual costs of using alternatives, estimated costs of using alternatives, actual costs of using prevention, and estimated costs of using prevention.

30. The method of claim 28, where the at least one process and settlement cost is based on at least one of: maximum time for disposition of an EDR case, peak disposition month for an EDR case, maximum time for switching between litigation and EDR, peak switch month for switching between litigation and EDR, average process costs per EDR case per month, average settlement cost per EDR case, percent of cases switching from EDR to ligitation, maximum time for disposition of a litigation case, peak disposition month for a litigation case, maximum time for switching between EDR and litigation, peak switch month for switching between EDR and litigation, average process costs per litigation case per month, average settlement cost per litigation case, and percent of cases switching from litigation to EDR.

31. The method of claim 28, where the at least one process and settlement cost is based on a phased-implementation of the business decision.

32. The method of claim 25, where the first direct cost and the second direct cost includes at least one reserve savings.

33. The method of claim 32, where the at least one reserve savings includes at least one of: an amount reserved for contingency cases, an amount of excess reserves, a hurdle rate, and an annual revenue.

34. The method of claim 25, where the at least one business relationship risk includes at least one of: a risk of losing an alliance, an employee risk, a supplier relationship risk, a capital provider/rate change risk, a customer risk, a competitor risk, a regulatory risk, and an insurance risk.

35. The method of claim 25, where the first risk reduction and the second risk reduction are based on at least one intellectual property risk.

36. The method of claim 35, where the at least one intellectual property risk includes at least one of: damage to intellectual property and loss of intellectual property.

37. The method of claim 25, where the first risk reduction and the second risk reduction are based on at least one litigation outcome risk.

38. The method of claim 37, where the at least one litigation outcome risk includes at least one of: a potential exposure risk and a likelihood of exposure risk.

39. The method of claim 25, where the first risk reduction and the second risk reduction are based on at least one adverse publicity risk.

40. The method of claim 39, where the at least one adverse publicity risk includes at least one of: damage to brand name, direct advertising expenses, corrective advertising expenses, selling costs, general costs, and administrative costs, increased lobbying, and increased regulation.
